(19) United States
(12) Patent Application Publication
(10) Pub. No.: US 2024/0208432 A1
(43) Pub. Date: Jun. 27, 2024

(54) Equipment Holder for a Vehicle

(71) Applicant: Bayerische Motoren Werke Aktiengesellschaft, Muenchen (DE)

(72) Inventors: Philipp HOFFMANN, Hannover (DE); Alexander KERSCHER, Markt Indersdorf (DE); Florian SCHLUMPP, Muenchen (DE)

(21) Appl. No.: 18/288,686

(22) PCT Filed: Apr. 6, 2022
(86) PCT No.: PCT/EP2022/059124

§ 371 Date: Oct. 27, 2023

(30) Foreign Application Priority Data
Apr. 30, 2021 (DE) 10 2021 111 200.1

(51) Int. Cl. B60R 11/04

(52) U.S. Cl. CPC B60R 11/04

(57) ABSTRACT

An equipment holder is provided for a vehicle. The equipment holder includes a first camera, a second camera, and a housing for receiving the cameras. The housing is configured to be attached to a right-hand side or left-hand side exterior part of the vehicle so that the first camera can view an area behind and to the side of the vehicle and the second camera can view an area to the side of the vehicle.

### BACKGROUND AND SUMMARY

The invention relates to an equipment holder on a vehicle. In particular, the invention relates to an equipment holder having a camera for replacing a lateral exterior mirror of the vehicle.

A motor vehicle typically comprises a right and a left exterior mirror, which are attached to the right and left side, respectively, of the vehicle such that they are in the field of view of a driver and permit him to see a region located laterally behind the motor vehicle. For aerodynamic reasons, attempts have been made to replace an exterior mirror with a camera which sees a region located laterally behind the motor vehicle and enables a display of the scanned image in the interior of the motor vehicle.

DE 10 2012 004 793 A1 discloses a motor vehicle having an electronic rearview mirror, which is used in conjunction with a display device designed as a multitouch-capable touchscreen.

Detail problems linked to the concept of the electronic rearview mirror have prevented comprehensive introduction up to this point. One object underlying the present invention is therefore to provide an improved technology for an equipment holder on a vehicle. The invention achieves this object by means of the subjects of the independent claims. Dependent claims reflect preferred embodiments.

According to a first aspect of the present invention, an equipment holder for a vehicle comprises a first camera; a second camera; and a housing for accommodating the cameras. The housing is configured here to be attached to a right or left outer side of the vehicle, so that the first camera can see a region located laterally behind the vehicle and the second camera can see a region located laterally of the vehicle.

The equipment holder can fulfill multiple functions which require scanning of the surroundings of the vehicle in an improved manner. In one embodiment, the equipment holder can be embodied as a sensor island or sensor pylon in which a plurality of sensors are integrated with one another. Thus, for example, one or more further cameras can also be arranged in the equipment holder. Problems in the arrangement of the sensors on the vehicle, for example for aerodynamic reasons or due to the optical influencing of the vehicle, can be addressed once and solved. It has been recognized that an equipment holder which is configured in particular to fulfill a rearview mirror functionality can advantageously be integrated with other sensors.

The region located laterally behind the vehicle, which can be seen by means of the first camera, can correspond to a region which can be seen using a classic exterior mirror. The first camera can have, for example, a field of view having a horizontal opening angle in the range of approximately 40° to approximately 60°, in one embodiment of approximately 51°, and a vertical opening angle in the range of approximately 40° to 50°, in one embodiment of approximately 43º. The resolution of the first camera can be at least 20 pixels per degree (px/°), preferably at least 40 px/°.

The second camera can be part of a surroundings monitoring system. It typically has an optical unit which enables a shorter focal length and a larger field of view than the first camera. A horizontal opening angle can be approximately 190° or more, a vertical opening angle approximately 155°. The resolution of the second camera is preferably at least approximately 7 px/°. A maximum distance of the region seen is typically less here than for the first camera.

The surroundings monitoring system can also be combined with further cameras, which can be attached in particular on the front or rear on the vehicle. For example, further cameras pointing forward can be provided in the region of a radiator grill or an upper boundary of a windshield; cameras pointing to the rear can be attached, for example, in the region of a taillight, a license plate, or an upper roof edge.

The housing is preferably configured to space apart the first camera laterally from the vehicle far enough that the first camera can see a widest point of the vehicle located behind the equipment holder. The vehicle preferably comprises a motor vehicle, in particular a motorcycle, a passenger vehicle, a truck, or a bus. The widest point can in particular be in the region of a rear wheel arch. To be able to reliably see this point, the housing can comprise a boom to move the camera away in the lateral direction from an outline of the vehicle. The housing can in this way be aerodynamically designed and noises which are induced by travel wind can be reduced. In another embodiment, the housing can be close to the vehicle and in particular can merge fluidly therein. In one embodiment, a part of the housing visible on the outer side of the vehicle is similar to a section of a rotational ellipsoid.

In one preferred embodiment, the equipment holder additionally comprises a third camera, which is accommodated in the housing such that it can see a region located laterally in front of the vehicle. The third camera can in particular comprise part of a system for movement control of the vehicle. The system can be configured to control the vehicle partially or completely autonomously in the longitudinal direction and/or transverse direction. By placing the third camera of the system in the equipment holder, a region relevant for the control of the vehicle can be scanned in an improved manner.

The equipment holder can furthermore comprise a signal light. The signal light can in particular comprise a directional indicator. The signal light can be seen from a predetermined region or a predetermined position with respect to the vehicle. For example, the signal light can be recognizable from laterally of the vehicle, from laterally to the rear, and/or from laterally from the front. The signal light can contribute to increasing a level of safety of the vehicle or other road users in the region of the vehicle.

In a further embodiment, the equipment holder comprises a lighting unit. In a first variant, the lighting unit comprises a position light to identify an outer outline of the vehicle. A position light visible from the front can emit white light, one pointing to the rear can emit red light. In a second variant, the lighting unit comprises a surroundings light, to facilitate entering or exiting the vehicle for a person. The surroundings light can comprise a projector here, in order to project a predetermined image on an underlying surface, such as a trademark logo, which indicates a producer of the vehicle.

In a further embodiment, the equipment holder comprises a cleaning unit for one of the cameras. A camera typically comprises an objective or a similar optical element which is attached in the region of a passage or a recess of the housing such that the camera is accommodated in the housing and can see the region assigned to the camera through the optical element. The cleaning unit is preferably configured to clean an outer side of the optical element. Fluid cleaning can be used for this purpose, which operates, for example, using a liquid or compressed air. A cleaning unit can also be provided which is attached to the surface of the optical element or is mounted in front of it. In this case, the cleaning unit can comprise one or more transparent layers, of which the outermost one is water repellent. Two layers can be supplied with an electrical voltage such that a water droplet deposited on the optical element is transported in a predetermined cleaning.

The equipment holder can additionally include a sensor for an ambient brightness. The sensor can in particular be configured to determine an incident solar radiation. In this case, the sensor is typically not imaging and can be oriented more upward, typically in contrast to the cameras. By determining ambient brightnesses on the right and the left side of the vehicle, an improved control of a climate control system (HVAC: heating, ventilation, air conditioning) of an interior of the vehicle can be possible.

In still a further embodiment, the equipment holder comprises a temperature sensor. The temperature sensor is configured to determine a temperature in the surroundings of the vehicle, in particular an air temperature. The temperature can be taken into consideration for the control of an HVAC system.

The equipment holder can be attached on the vehicle such that, in the case of a collision with an object or a person, it is separated from the vehicle in a controlled manner. For this purpose, the equipment holder can include an intended breakpoint or a snap connection. Sensors which are accommodated in the housing can be connected by means of cables to the vehicle, wherein a cable can be used as a leash for a separated equipment holder. A cable can also include a tear point which can operate as the intended breakpoint of the cable. One or more cables of the sensors can be connected to the vehicle by means of a plug connector. The plug connector can be configured to detach automatically if a predetermined tensile load is exceeded.

It is particularly preferred that the equipment holder is configured to be attached in a region of the vehicle which extends behind and above an axle of a front wheel of the vehicle. A neutral position of the front wheel is presumed for the determination of the axis of rotation. Aerodynamics of the vehicle can thus be influenced less. It is furthermore preferred for the camera not to be attached behind the longitudinal position of a bulkhead, an A-pillar of the vehicle, and/or a front edge of a front side door. To protect the equipment holder from road dirt in an improved manner, it is furthermore preferred for it to be attached at a height on the vehicle at which a normal on the vehicle body points above the horizontal. This height is preferably above a widest point of the vehicle in this region. The preferred height can be approximately 80 to 120 cm on a typical vehicle. In one particularly preferred embodiment, the equipment holder is attached at a height of approximately 100 cm on the vehicle. The equipment holder is preferably laterally oriented here.

In different embodiments, the equipment holder can be located in a lateral trough of the vehicle, can press against the vehicle, or can be spaced apart from the vehicle by means of a boom or a strut. The equipment holder typically has to be spaced apart farther from the vehicle the farther to the rear it is attached, in order to meet specifications for the visibility of predetermined regions on the vehicle. In one embodiment, the equipment holder can be arranged in the region of a front fender. The equipment holder can be arranged in a region on which conventionally an exterior mirror is attached. This region is usually approximately triangular and is also called the mirror triangle.

It is particularly preferred that the equipment holder is configured to be attached to vehicles of different vehicle types. A development expenditure for equipping the equipment holder with cameras and possibly further sensors can be made once and utilized on various vehicle types. Development and production costs for the equipment holder and one of the vehicles can thus be reduced.

The equipment holder can include a mounting plate for attaching the first and the second camera, and a fastening plate for attaching to the vehicle. The mounting plate and the housing are attached on the fastening plate here. Optional further sensors can also be attached to the mounting plate. The fastening plate can be adapted specifically to a predetermined vehicle type, so that by exchanging the fastening plate, the equipment holder can be fastened on another vehicle type. The housing can also be exchangeable, wherein the housing can also be assigned to a predetermined vehicle type. The equipment holder can thus be configured like a modular system for use on various vehicle types. The mounting plate can be flexibly equipped with sensors depending on planned equipment of the vehicle.

According to a further aspect of the present invention, a vehicle comprises an equipment holder described herein. The vehicle preferably comprises at least two equipment holders, of which one is attached on a right and the other on a left vehicle side. Furthermore, the vehicle can have a processing system, which is configured to process signals provided by sensors of the equipment holder. The vehicle can also include a display device, which is configured to display images that can be provided on the basis of scans of the surroundings of the vehicle by means of one of the cameras.

According to still a further aspect of the present invention, a system comprises a first fastening plate for attachment to a vehicle of an assigned first vehicle type; a second fastening plate for attachment to a vehicle of an assigned second vehicle type, wherein the fastening plates are each configured for attachment to a right or to a left outer side of the vehicle; a mounting plate having a first and a second camera; and a housing for attachment to one of the fastening plates such that the first camera can see a region located laterally behind the vehicle and the second camera can see a region located laterally of the vehicle.

The vehicle types are preferably different from one another here. The system can be used like a construction kit to provide a matching equipment holder for a vehicle.

In the system, a first housing can be provided for attachment to the first mounting plate and a second housing can be provided for attachment to the second mounting plate. In this way, the housings can each be assigned to one vehicle type. Requirements, for example, with respect to a design, an aerodynamic formation, or a housing color can thus be fulfilled in an improved manner with respect to the respective vehicle. The mounting plate and the cameras and possibly further sensors can be universally provided. The mounting plate can be prepared for attachment of different sensors, in particular different cameras. For this purpose, the mounting plate can have corresponding fastening points or recesses, at which the cameras can be fastened.

The processing unit can be configured to entirely or partially execute a method described herein. For this purpose, the processing unit can comprise a programmable microcomputer or microcontroller and the method can be provided in the form of a computer program product having program code means. The computer program product can also be stored on a computer-readable data carrier. Features or advantages of the method can be transferred to the device or vice versa.

The invention will now be described in more detail with reference to the appended drawings.

### BRIEF DESCRIPTION OF THE DRAWINGS

FIG. 1 illustrates an equipment holder on a vehicle;

FIG. 2 illustrates a system having components of an equipment holder;

FIGS. 3 to 5 illustrate embodiments of an equipment holder on a vehicle;

FIGS. 6 and 7 illustrate views of a further embodiment of an equipment holder on a vehicle; and

FIGS. 8 to 10 illustrate views of still a further embodiment of an equipment holder for attachment to a vehicle.

### DETAILED DESCRIPTION OF THE DRAWINGS

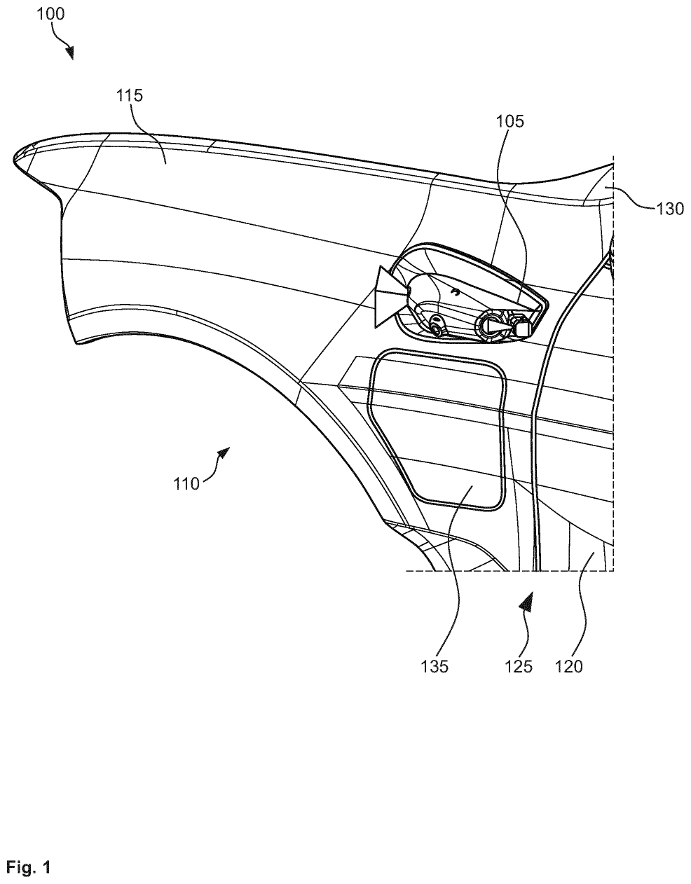

FIG. 1 shows an exemplary vehicle 100 having an equipment holder 105. A left front region of the vehicle 100 is shown. A front fender 115 extends in the direction of a hood (not shown) via a wheel arch 110. The fender 115 is delimited at the rear by a side door 120, which is attached to the vehicle 100 in the region of a bulkhead 125. Above the bulkhead 125, the fender 115 merges into a vehicle pillar 130, which can also be called an A-pillar.

With respect to an axis of rotation of a front wheel which is accommodated in the front wheel arch 110, the equipment holder 105 is preferably located farther to the rear and farther upward. The equipment holder 105 is attached to an outer side of the vehicle 100 in the lateral direction. In the embodiment shown, it is located above an access flap 135, behind which an electrical connection for charging an electrical energy storage device of the vehicle 100 can be located.

A scanning range of a camera in the equipment holder 105 is indicated symbolized by a cone opening in the travel direction of the vehicle 100. A cone expanding upward symbolizes a detection range of an exemplary light sensor. A cone recognizable further to the rear, which opens counter to the travel direction, symbolizes a fluid jet of a cleaning unit for an optical element in the equipment holder 105.

It is proposed that the equipment holder 105 is configured to be equipped with a plurality of sensors which are each configured to scan a predetermined aspect of the surroundings of the vehicle 100. In addition, it is proposed that the equipment holder 105 be constructed modularly, so that it can be used on different vehicle types of vehicles 100.

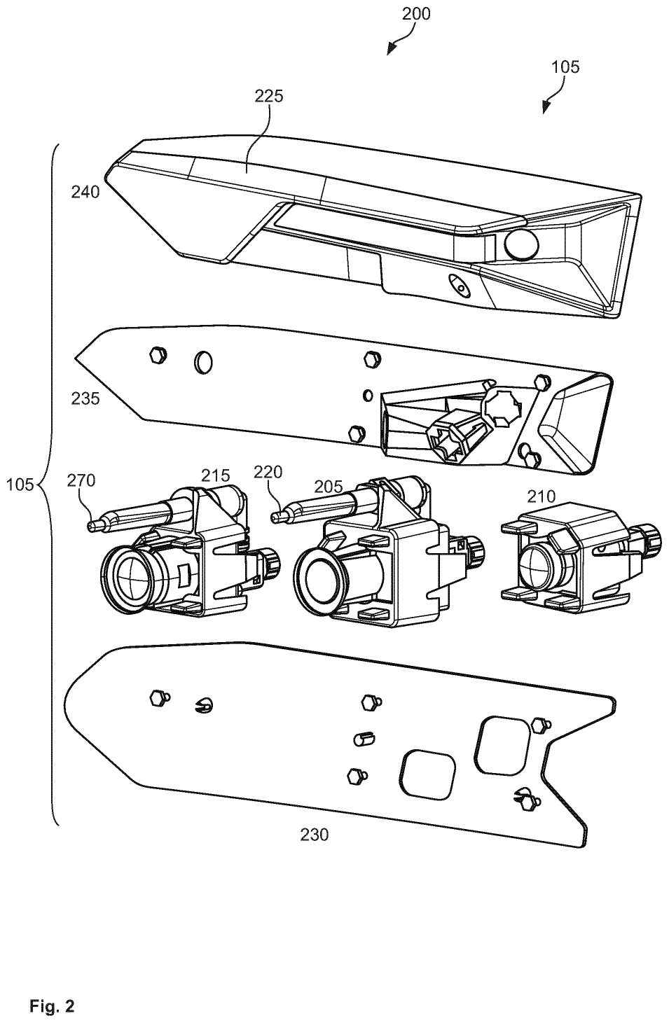

FIG. 2 shows a system 200 for providing an equipment holder 105. In the illustrated embodiment, the equipment holder 105 comprises a first camera 205, a second camera 210, and an optional third camera 215. The first camera 205 is configured to scan a predetermined region located laterally behind the vehicle 100 and the second camera 210 is configured to scan a predetermined region located laterally of the vehicle 100. The third camera 215 is preferably configured to scan a predetermined region which extends laterally in front of the vehicle 100. Cleaning units 220 for optical elements of the first camera 205 and the second camera 215 are provided by way of example.

The equipment holder 105 can accommodate still further sensors or actuators. In the illustrated embodiment, for example, a signal light 225 is provided, which can be used in particular as a directional indicator. Other possible actuators comprise a position light or a surroundings light. Exemplary additional sensors comprise a light sensor, a microphone, and a temperature sensor.

The system 200 comprises a fastening plate 230 for attachment to a right or left outer side of a vehicle 100 of a predetermined vehicle type, a mounting plate 235 on which the cameras 205 to 215 and optionally further sensors or actuators can be attached, and a housing 240.

It is proposed that various fastening plates 230 be provided, which are each assigned to a predetermined vehicle type, so that the equipment holder 105 can be assembled for attachment on a vehicle 100 of a predetermined vehicle type. Different housings 240 are preferably also provided, which can be assigned either to the vehicle type or the fastening plate 230. In this case, the housing 240 determines an external appearance of the equipment holder 105 and can also ensure that the equipment holder 105 integrates into an overall image of the vehicle 100 and is securely fastened thereon. The mounting plate 235 can also be equipped according to the construction kit principle with different cameras 205 to 215 and further sensors and/or actuators, in order to be used on a predetermined vehicle 100. The mounting plate 235 having elements 205 to 220 attached thereon can easily be installed or maintained as a unit that can be handled separately. In one embodiment, an arrangement made up of the mounting plate 235 having sensors and/or actuators fastened thereon can be used in unchanged form on vehicles 100 of various vehicle types, in that it is combined with a matching fastening plate 230 and/or a matching housing 240.

To attach the equipment holder 105 to a vehicle 100, first the fastening plate 230 can be fastened on the vehicle 100, in particular on an inner side of the vehicle 100. Detent elements (clips) can be used for fixing, which can already be preinstalled either on the side of the fastening plate 230 or on the side of the vehicle 100. The mounting plate 235 having the sensors and/or actuators 205 to 220 can then be attached from the outside on the vehicle 100 and connected to the fastening plate 230, in particular by means of screwing on. Subsequently, the housing 240 can be attached to the outer side of the vehicle 100. Connections of sensors and/or actuators 205 to 220 can then be connected to corresponding systems on board the vehicle 100. These connections can in particular be accessible from the wheel arch 110.

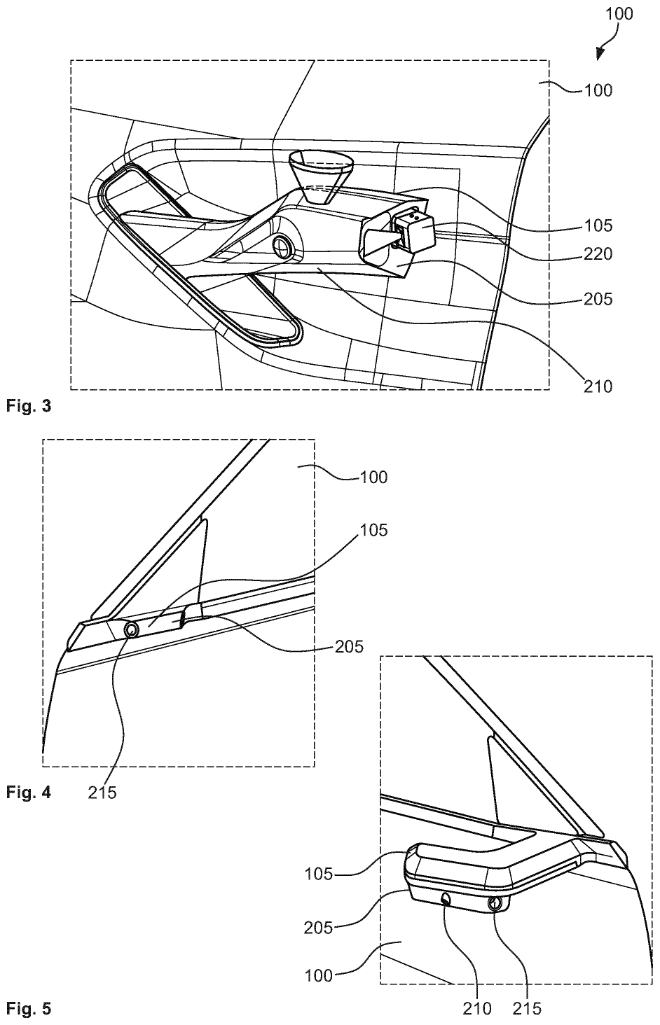

FIGS. 3 to 5 show further embodiments of an equipment holder 105 on a vehicle 100. The embodiment of the equipment holder 105 shown in FIG. 3 clings in a lateral depression in the outer skin of the vehicle 100. The equipment holder 105 is essentially T-shaped here, and has an end section directed counter to the travel direction of the vehicle 100, on which the first camera 205 is attached in order to see a region behind the vehicle 100. A cleaning unit 220 is optionally provided in this region. The second camera 210 is oriented toward the side and slightly downward. A cone opening upward in FIG. 3 symbolizes the opening range of an optional light sensor.

With reference to FIG. 4, the equipment holder 105 shown is attached closely to the vehicle 100. In the present case, the equipment holder 105 is attached close to the A-pillar 130 on the side door 120. The equipment holder 105 essentially has the shape of a tube here, which extends along the travel direction of the vehicle 100. The third camera 215 is attached in a front region and the first camera 205 is attached in a rear region.

FIG. 5 shows a further embodiment of an equipment holder 105, which is attached at a similar point on the vehicle 100 to the embodiment of FIG. 4. The equipment holder 105 comprises a boom here, however, so that the cameras 205, 210, 215 can be located farther outward with respect to a longitudinal axis of the vehicle 100. The cameras 205 to 215 are arranged offset along a travel direction of the vehicle 100.

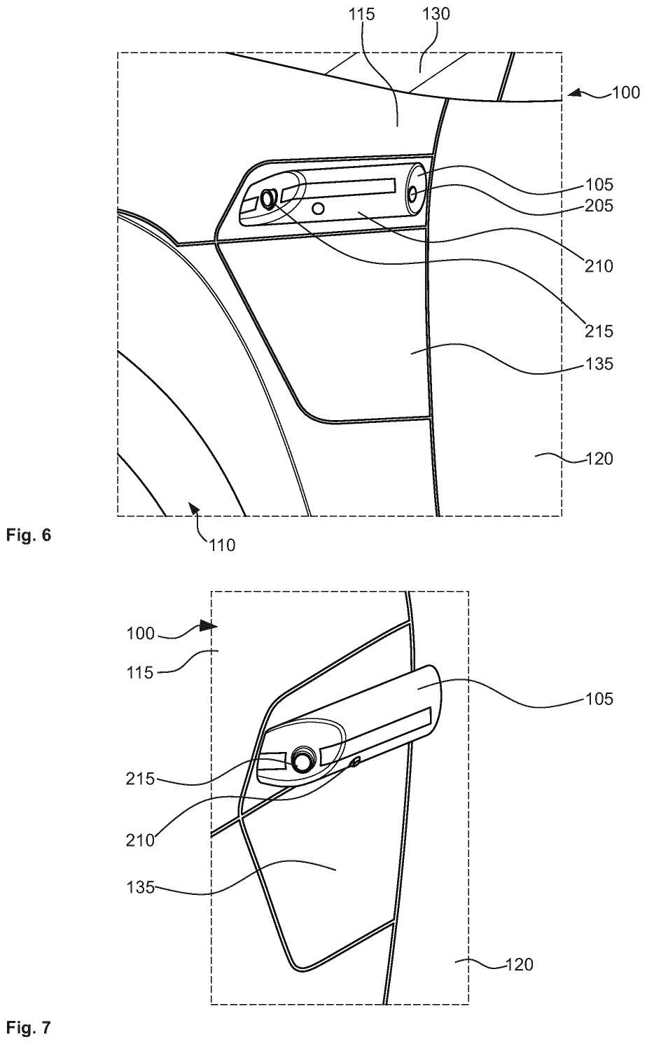

FIGS. 6 and 7 show still a further embodiment of an equipment holder 105 on a vehicle 100. FIG. 6 shows a lateral view, FIG. 7 shows a partial front view. Similarly to in the embodiment of FIG. 4, the equipment holder 105 is essentially cylindrical and oriented along a travel direction of the vehicle 100. The equipment holder 105 is attached here at a similar point to in the embodiment of FIG. 1. The equipment holder 105 shown is essentially cylindrical, wherein ends pointing to the front and to the rear can each be beveled. The cylinder can press against an outer skin of the vehicle 100 or can protrude from it at a predetermined distance. In the embodiment shown, the equipment holder 105 protrudes slightly angled from a lateral surface of the vehicle 100.

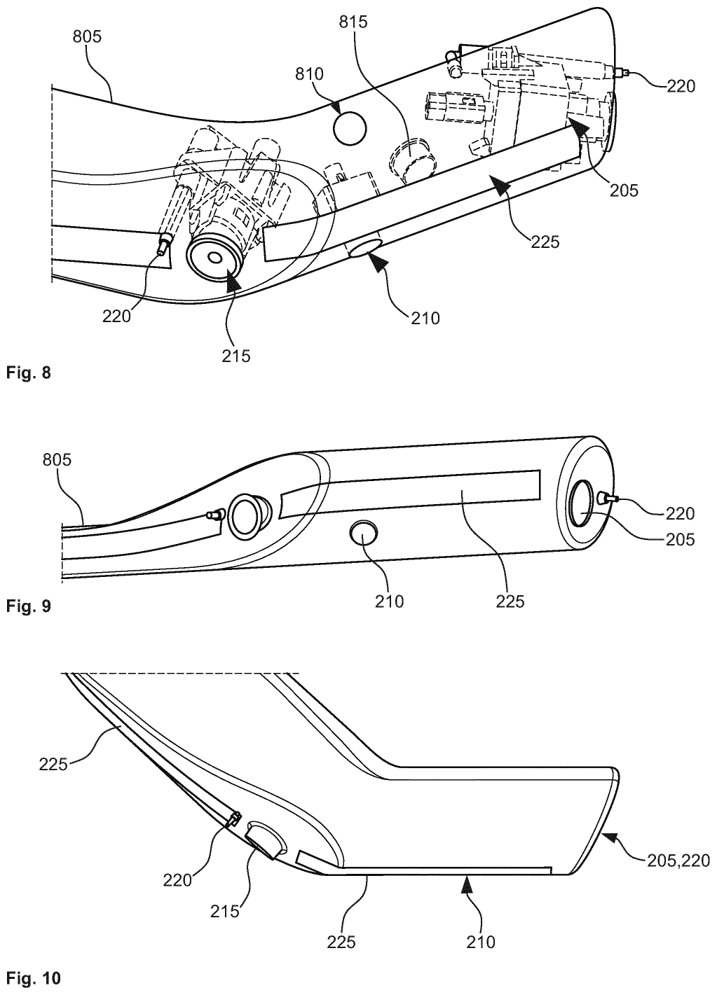

FIGS. 8 to 10 show views of still a further embodiment of an equipment holder 105 for attachment to a vehicle 100. FIG. 8 shows the equipment holder 105 in a partially transparent view, FIG. 9 from a lateral view, and FIG. 10 in a top view. The embodiment shown is similar to that of FIGS. 6 and 7, but preferably includes a boom 805 in order to move a cylindrical section, in which the cameras 205 and 210 and possibly still further sensors and/or actuators are accommodated, farther away from the vehicle 100 transversely to the travel direction. A light sensor 810 and a microphone 815 are additionally provided by way of example in this embodiment.

### LIST OF REFERENCE NUMERALS

100 vehicle
105 equipment holder
110 wheel arch
115 front fender
120 side door
125 bulkhead
130 vehicle pillar
135 access flap
200 system
205 first camera
210 second camera
215 third camera
220 cleaning unit
225 signal light (directional indicator)
230 fastening plate
235 mounting plate
240 housing
805 boom
810 light sensor
815 microphone

1.-12. (canceled)

13. An equipment holder for a vehicle, comprising:
a first camera;
a second camera;
a housing that accommodates the first and second cameras,
wherein the housing is configured to be attached to a right or left outer side of the vehicle so that the first camera images a region located laterally behind the vehicle and the second camera images a region located laterally of the vehicle.

14. The equipment holder according to claim 13, wherein
the housing is configured to space apart the first camera laterally from the vehicle far enough that the first camera images a widest point of the vehicle located behind the equipment holder.

15. The equipment holder according to claim 13, further comprising:
a third camera accommodated in the housing, wherein the third camera images a region located laterally in front of the vehicle.

16. The equipment holder according to claim 13, further comprising a signal light on the housing.

17. The equipment holder according to claim 16, further comprising:
a lighting unit on the housing.

18. The equipment holder according to claim 13, further comprising:
a cleaning unit for one of the first or second cameras.

19. The equipment holder according to claim 13, wherein
the equipment holder is configured to be attached in a region of the vehicle which extends behind and above an axle of a front wheel and in front of a bulkhead of the vehicle.

20. The equipment holder according to claim 13, wherein
the equipment holder is configured to be attached to vehicles of various vehicle types.

21. The equipment holder according to claim 20, further comprising:
a mounting plate for attachment of the first and the second camera; and
a fastening plate for attachment to the vehicle, wherein
the mounting plate and the housing are attached to the fastening plate.

22. A vehicle comprising an equipment holder according to claim 13.

23. A system, comprising:
a first fastening plate for attachment to a vehicle of an assigned first vehicle type;
a second fastening plate for attachment to a vehicle of an assigned second vehicle type;
wherein the first and second fastening plates are respectively configured to be attached to a right or a left outer side of the vehicle;
a mounting plate having a first and a second camera; and
a housing for attachment to one of the first and second fastening plates such that the first camera images a region located laterally behind the vehicle and the second camera images a region located laterally of the vehicle.

24. The system according to claim 23, wherein
the housing is a first housing for attachment to a first mounting plate and is a second housing for attachment to a second mounting plate.
